(19) United States
(12) Patent Application Publication
(10) Pub. No.: US 2010/0279256 A1
(43) Pub. Date: Nov. 4, 2010

(54) ARRAY OF COSMETIC PRODUCT CLUSTERS

(76) Inventors: Elizabeth Bilyeu Twohy, Cockeysville, MD (US); Wendy Michalski, Baltimore, MD (US); Kerry Michael Cavanaugh, Baltimore, MD (US); Katie Louise DiSylvestro, Forest Hill, MD (US); Samuel Peter Thomson, Geneva (CH)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/436,085

(22) Filed: May 5, 2009

Related U.S. Application Data
(60) Provisional application No. 61/050,463, filed on May 5, 2008.

(51) Int. Cl. G09B 19/00; A47G 29/00

(52) U.S. Cl. 434/100; 211/85.26

(57) ABSTRACT

An array of cosmetic product clusters designed to help consumers obtain a desired end-look, the array comprising a first cluster comprising cosmetic products corresponding to a first desired end-look and a second cluster comprising cosmetic products corresponding to a second desired end-look. The clusters are adjacent to one another and each cluster comprises at least two cosmetic product segments selected from eye products, lip products, face products, nail products, and cosmetic implements. Within each segment there is at least one individual cosmetic product that is not present in a corresponding segment of any other cluster.

### CROSS REFERENCE TO RELATED APPLICATION

This application claims the benefit of U.S. Provisional Application Ser. No. 61/050,463, filed May 5, 2008.

### FIELD OF THE INVENTION

The present invention is directed to an array of cosmetic product clusters designed to help consumers obtain a desired end-look.

### BACKGROUND OF THE INVENTION

Cosmetic products are available for purchase in many venues, including grocery stores, big-box stores, and pharmacies. In these venues, cosmetic sections have been organized fairly consistently since the introduction of mass-marketed cosmetics: display space is apportioned among various cosmetics brands, and within each brand's space, cosmetics products are grouped by where or how the cosmetic product is used. Lip products of all types and appearances are grouped in one area, eye products of all types and appearances are grouped in another area, face products of all types and appearances are grouped in another area, and nail products of all types and appearances are grouped in yet another area. For instance, powders, foundations, concealers, etc. are grouped together; mascaras, eye shadows, and eye liners are grouped together; lip sticks and lip glosses are grouped together; and nail polish and press-on nails are grouped together. As a result, manufacturers and retailers have essentially mandated consumers' adoption of a limiting and non-intuitive “product-centric” shopping mindset. This has forced consumers to think about their cosmetic needs by body part or task (e.g., face vs. eye vs. lip), rather than by their “total desired appearance” goal.

With the current cosmetic product organization, a consumer must decide on a brand of cosmetics, know what type of product she wants to purchase, locate the corresponding group of products, and then wade through numerous products within that group to find the product she is looking for. For example, if a consumer wants to purchase a lip product, she must find the lip group, and then look though all of the various lip sticks and glosses to find the type of lip product with the shade and benefits she desires. Then, if she wants to purchase another cosmetic product that is in a different group, for example eye shadow, she must repeat the process all over again. Browsing through a large number of cosmetics products and considering different functions, shades, and benefits is time consuming and makes for an overwhelming experience for many consumers. There are too many choices and it is hard for consumers to feel confident in their selections.

Further, because cosmetic products from different segments are not intermingled, it is hard for a consumer to put together an entire end look. For example, a consumer may know which foundation she prefers, but she may not be familiar with additional, complementary cosmetic products that would give her a complete look, such as blush, lipstick, and eye shadow. Current cosmetic displays are not designed to help consumers locate complementary products to achieve a desired end-look.

To solve these problems, there exists a need to organize cosmetic product displays differently than they are organized today. Organizing cosmetic product displays by desired end-look may help consumers navigate the daunting cosmetic aisle because a consumer can identify with an attitude or desired end-look of a group of products and then make product choices from that group of products. This will decrease the number of products a consumer needs to consider so it will lessen consumer anxiety. Also, consumers will be more satisfied with the cosmetics products they purchase from these groups because the suggested product combinations will help them achieve their desired end-look more effectively than simply purchasing products at random with no guidance. A more intuitive display system will make it easier and more pleasurable for consumers to find the products they desire and complementary products.

These are all objects of the present invention; embodiments of the present invention may combine various objects mentioned. A particular embodiment may, but need not, embody every object of the invention.

### SUMMARY OF THE INVENTION

The present invention is directed to an array of cosmetic product clusters designed to help consumers obtain a desired end-look, the array comprising: a first cluster comprising cosmetic products corresponding to a first desired end-look and a second cluster comprising cosmetic products corresponding to a second desired end-look; wherein the clusters are adjacent to one another, and wherein each cluster comprises at least two cosmetic product segments selected from eye products, face products, lip products, nail products, and cosmetic implements; wherein within each segment there is at least one product that is not present in a corresponding segment of any other cluster.

The present invention is also directed to an array of cosmetic product clusters designed to help consumers obtain a desired end-look, the array comprising at least two cosmetic product clusters selected from eye products, face products, lip products, nail products, and cosmetic implements; wherein the clusters are adjacent to one another; and wherein each cluster comprises at least two cosmetic product segments selected from various desired end-looks; wherein within each segment there is at least one product that is not present in a corresponding segment of any other cluster.

The present invention is also directed to a method of merchandising cosmetic products comprising the steps of: defining two or more desired end-looks and clustering the cosmetic products according to the desired end-looks such that two or more clusters of cosmetic products are formed and such that the cosmetic products in each cluster enable consumers to achieve the desired end-looks; wherein at least two clusters comprise at least two cosmetic product segments selected from eye products, face products, lip products, nail products, and cosmetic implements; wherein within each segment there is at least one product that is not present in a corresponding segment of any other cluster.

The present invention is also directed to a method of merchandising cosmetic products comprising the steps of: clustering the cosmetic products into eye products, lip products, face products, nail products, and cosmetic implements such that two or more clusters of cosmetic products are formed; and defining two or more desired end-looks; wherein at least two clusters comprise at least two cosmetic product segments selected from various desired end-looks; wherein within each segment there is at least one product that is not present in a corresponding segment of any other cluster.

The present invention is also directed to a display system comprising an array of cosmetic product clusters designed to help consumers obtain a desired end-look, the array comprising: a first cluster comprising cosmetic products corresponding to a first desired end-look; and a second cluster comprising cosmetic products corresponding to a second desired end-look; wherein the clusters are adjacent to one another, and wherein each cluster comprises at least two cosmetic product segments selected from eye products, face products, lip products, nail products, and cosmetic implements; wherein within each segment there is at least one product that is not present in a corresponding segment of any other cluster.

The present invention is also directed to a display system comprising an array of cosmetic product clusters designed to help consumers obtain a desired end-look, the array comprising: at least two cosmetic product clusters selected from eye products, face products, lip products, nail products, and cosmetic implements; wherein the clusters are adjacent to one another; and wherein each cluster comprises at least two cosmetic product segments selected from various desired end-looks; wherein within each segment there is at least one product that is not present in a corresponding segment of any other cluster.

The present invention is also directed to a cosmetic products display system comprising: a space for displaying cosmetic products that consumers can use to obtain one or more desired end-looks; and sensory assets that (i) divide the space into a plurality of adjacent clusters, (ii) identify a first cluster comprising for-purchase cosmetic products corresponding to a first desired end-look, and (iii) identify a second cluster comprising for-purchase cosmetic products corresponding to a second desired end-look; wherein the clusters are adjacent to one another; wherein each cluster comprises at least two cosmetic product segments selected from eye products, face products, lip products, nail products, and cosmetic implements; and wherein within each segment there is at least one individual cosmetic product that is not present in a corresponding segment of any other cluster.

Recent research by the inventors has demonstrated that consumers have differing aspirational goals for their desired end-look, driven by: 1) differences in their underlying attitudes/personal sense of style towards cosmetics, and/or 2) the occasion or environment (e.g., daytime professional, evening social event) that motivates their usage. Importantly, differentiating by desired end-look and attitude appears to resonate with consumers globally. To achieve both better shopping experiences for consumers and improved product selection satisfaction, brands may organize cosmetic products with various properties and shades by these different desired end-looks. Research has shown that when guided by desired end-look in navigation, consumer satisfaction increases.

Organization by “total desired appearance,” or “desired end-look,” will make it easier for consumers to find the right set of products and colors/shades best suited to meet their aspirational appearance goal, thereby increasing consumers' satisfaction with both the shopping process and compatibility of the products to work together to achieve that end-look. This benefit is specifically targeted to color cosmetics (face, eye, lip, nail, etc.). However, this application may also be broadly applicable to any category with a range of forms, functions, etc. that provide differentiating appearance benefits for helping the consumer identify the right product for her (hair color, hair styling, skin and body care, etc).

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic of a first exemplary array of the present invention.

FIG. 2 is a schematic of a second exemplary array of the present invention.

FIG. 3 is a schematic of a third exemplary array of the present invention.

FIG. 4 is a schematic of a fourth exemplary array of the present invention.

FIG. 5 is a schematic of a fifth exemplary array of the present invention.

### DETAILED DESCRIPTION OF THE INVENTION

The present invention may be understood more readily by reference to the following detailed description. It is to be understood that the scope of the claims is not limited to the specific ingredients, methods, conditions, devices, or parameters described herein, and that the terminology used herein is not intended to be limiting of the claimed invention. Also, as used in the specification, including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent basis “about,” it will be understood that the particular values form another embodiment. All ranges are inclusive and combinable.

The arrays, display systems, and methods of the present invention can comprise, consist of, and consist essentially of the features of the invention described herein, as well as any of the additional or optional ingredients, components, steps, or limitations described herein.

The term “array” as used herein refers to a number of cosmetic products arranged in clusters and segments, wherein the clusters and segments are defined differently from one another. For instance, clusters may be defined by desired end-looks while segments may be defined by cosmetic products. Or, clusters may be defined by cosmetic products while segments may be defined by desired end-looks.

The term “cluster” as used herein refers to a grouping of a number of cosmetic products within an array. Clusters may be defined by desired end-looks or by cosmetic products.

The term “segment” as used herein refers to a grouping of a number of cosmetic products within a cluster. Segments may be defined by desired end-looks or by cosmetic products.

The term “corresponding segments” as used herein refers to two or more segments which are defined by the same desired end-look or cosmetic product. For example, a face products segment in one cluster corresponds to a face products segment in another cluster. Likewise, a natural desired end-look segment in one cluster corresponds to a natural desired end-look segment in another cluster.

The term “end look” as used herein refers to a physical appearance of the eyes, eyebrows, face, neck, chest, lips, hands, feet, or nails which a consumer may achieve by using one or a combination of cosmetic products.

The term “desired end-look” as used herein refers to an end look that is preferred by consumers. Desired end-looks may vary depending on consumer preferences, attitudes, trends, seasons, etc. Organization by desired end-look will make it easier for consumers to find the right set of products and colors/shades best suited to meet their aspirational appearance goal, thereby increasing consumers' satisfaction with both the shopping process and compatibility of the products to work together to achieve that end-look.

The term “cosmetic product” as used herein refers to any personal care product that is suitable for use in, on, or around the eyes, eyebrows, face, neck, chest, lips, hands, feet, or nails. Exemplary cosmetic products include cosmetic implements, eye products, face products, lip products, and nail products. Examples of cosmetic products are found in U.S. Pat. No. 6,325,995, issued to El-Nokaly et al. Dec. 4, 2001 and directed to an exemplary lip product; U.S. Pat. No. 6,696,049, issued to Vatter et al. Feb. 24, 2004 and directed to an exemplary face product; and U.S. Pat. No. 6,503,495, issued to Alwattari et al. Jan. 7, 2003; all incorporated herein by reference. The preceding examples of cosmetic products suitable for use in the present invention are given solely for the purpose of illustration and are not to be construed to limit scope of the present invention as many variations thereof are possible without departing from the spirit and scope of the invention.

The term “individual cosmetic product” as used herein refers to a cosmetic product that has a specific function (e.g., foundation, mascara, lip stick, pencil sharpener), benefit (e.g., oil-free, moisturizing, age-defying, waterproof, volumizing, lengthening, moisturizing, long-wear, sharpens large pencils), shade (e.g. ivory, natural, beige, almond, sable, black, brown, cocoa bean, sugarplum, watermelon, hot pink), and the like. For example, an oil-free foundation in ivory is a individual cosmetic product, while an oil-free foundation in almond is a different individual cosmetic product.

The term “cosmetic implement” as used herein refers to any device that aides in the application or removal of cosmetic products or helps create or maintain desired looks for the eyes, face, lips, and nails. Exemplary cosmetic implements include pencil sharpeners, applicators, brushes, tweezers, combs, eyebrow scissors, mascara applicators, eyelash curlers, blotting sheets, sponges, puffs, cotton balls, electrostatic sprayers, airbrushes, motorized applicators, nail clippers, and nail files.

The term “eye product” as used herein refers to any cosmetic product that is suitable for use in, on, or around the eyes or eyebrows. Exemplary eye products include eye liners, eye shadows, eyebrow pencils, mascaras, eye makeup removers, false eyelashes, under-eye concealers, and eye creams.

The term “face product” as used herein refers to any cosmetic product that is suitable for use in, on, or around the face, neck, or chest. Exemplary face products include concealers, correctors, primers, blushes, bronzers, highlighters, shimmers, foundations, powders, sunscreens, brushes, and face creams.

The term “lip product” as used herein refers to any cosmetic product that is suitable for use in, on, or around the lips. Exemplary lip products include lip primers, lip pencils, lipsticks, lip glosses, lip balms, lip stains, lip creams.

The term “nail product” as used herein refers to any cosmetic product that is suitable for use in, on, or around the hands, feet, or nails. Exemplary nail products include nail polish, nail polish remover, cotton balls, press-on nails, lotions, and other cosmetic products or implements suitable for use on the hands, feet, or nails.

The term “adjacent” as used herein refers to things that are not distant. For instance, adjacent clusters may be either vertically next to one another, horizontally next to one another, or in rectangular or non-rectangular blocks close to one another. Even if clusters have space between them, such as two clusters in a cosmetics aisle with ten feet of space between them, or one cluster in an aisle and one cluster in an end cap, the clusters are still considered adjacent.

The term “beauty issue” as used herein refers to a concern or problem with the eyes, eyebrows, face, neck, chest, lips, hands, feet, or nails. Exemplary beauty issues include acne, wrinkling, dry skin, oily skin, dark circles under the eyes, uneven skin tone, and aging.

The term “display system” as used herein refers to a means of exhibiting cosmetics products. A display system may involve fixturing in a retail store such as shelving or electronic displays. Or, a display system may be represented in a printed instruction, a printed flyer, a printed advertisement, an electronic advertisement, an internet site, and combinations thereof.

The term “sensory asset” as used herein refers to any means of separating, dividing, calling attention to, comparing to, distinguishing from, explaining, or highlighting different clusters, segments, and products. Sensory assets include visual assets, audio assets, olfactory assets, and the like. Exemplary visual assets include color, finish, transparency, images, alphanumeric characters, printed words, nomenclature, typography, icons, patterns, shapes, objects, illumination, and the like. Exemplary audio assets include music, sounds, and audio words. Exemplary olfactory assets include perfumes and scents.

The following exemplary arrays, display systems, and methods further describe and demonstrate embodiments within the scope of the present invention. These examples are given solely for the purpose of illustration and are not to be construed as limitations to the present invention as many variations thereof are possible without departing from the spirit and scope of the invention. It is therefore intended to cover in the appended claims all such modifications that are within the scope of this invention.

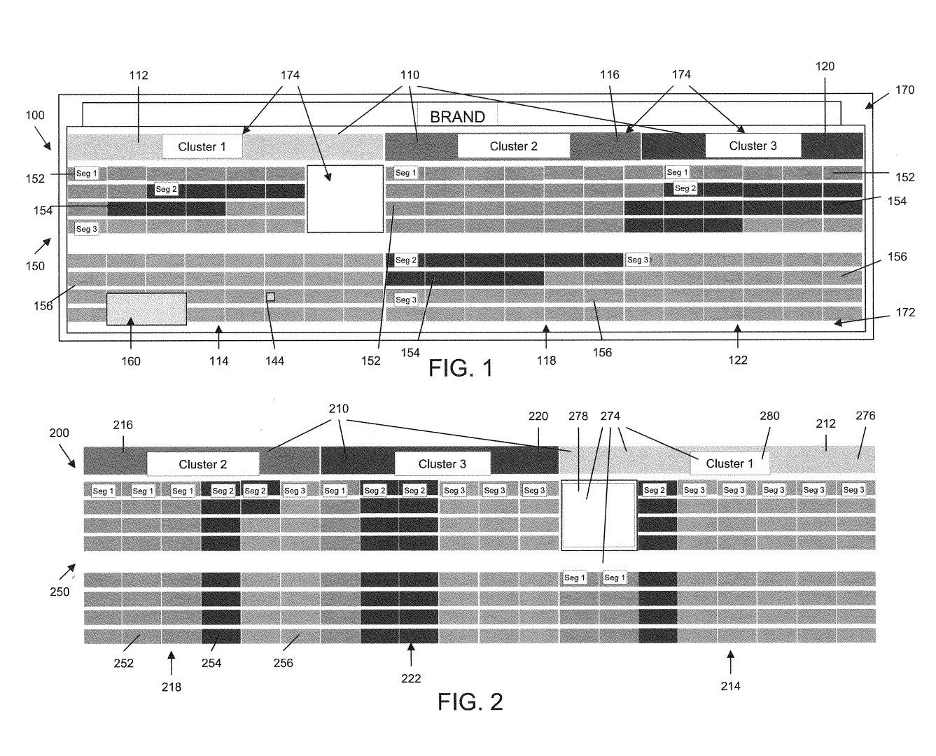

FIG. 1 illustrates an exemplary array 100 of cosmetic product clusters 110 designed to help consumers obtain a desired end-look. In one embodiment, array 100 comprises a first cluster 112 comprising cosmetic products 114 corresponding to a first desired end-look, a second cluster 116 comprising cosmetic products 118 corresponding to a second desired end-look, and a third cluster 120 comprising cosmetic products 122 corresponding to a third desired end-look. Desired end-looks may be selected from the following non-limiting examples: pure chic, playfully edgy, my best me, natural, classic, dramatic, young, middle-age, mature, evening, formal, work, professional, casual, anti-aging, organic/mineral, current trends, color pop, fresh faces, AM to PM perfect, and combinations thereof. In one embodiment, first cluster 112 corresponds to a natural end-look, second cluster 116 corresponds to a dramatic end-look, and third cluster 120 corresponds to a classic end-look. In another embodiment, array 100 comprises one or more clusters 110 identifying a beauty issue and comprising products to address that issue. In a further embodiment, array 100 comprises one or more clusters 110 comprising cosmetic implements 160.

As shown in FIG. 1, at least two clusters 110 comprise at least two cosmetic product segments 150. In one embodiment, each of three clusters 110 comprises three segments 150: segment one 152, segment two 154, and segment three 156. Exemplary cosmetic product segments 150 include eye products, face products, lip products, nail products, and cosmetic implements. In one cluster 110 embodiment, segment one 152 comprises eye products, segment two 154 comprises lip products, and segment three 156 comprises face products. In some embodiments, within each segment 150 there is at least one individual cosmetic product 144 that is not present in a corresponding segment 150 of any other cluster 110. For example, in one embodiment first cluster 112 comprises segment one 152 comprising eye products, and second cluster 116 also comprises segment one 152 comprising eye products; there may be an individual mascara in segment one 152 of first cluster 112 that is not present in segment one 152 of second cluster 116. In another embodiment, within each segment 150 there is at least one individual cosmetic product that is not present anywhere else in the array 100.

FIG. 1 also illustrates how clusters 110 may be displayed in a display system 170. In one embodiment, there exists a cosmetic products display system 170 comprising a space 172 for displaying cosmetic products that consumers can use to obtain one or more desired end-looks. Display system 170 may comprise sensory assets 174 to divide space 174 into a plurality of adjacent clusters 110 and distinguish clusters 110 from one another.

In one embodiment, as shown in both FIGS. 1 and 2, clusters 110, 210 are adjacent to one another and arranged horizontally. In one embodiment, as shown in FIG. 1, cosmetic product segments 150 are arranged substantially vertically within each cluster 110. For example, segment one 152 is located above segment two 154, which is in turn located above segment three 156. In another embodiment, as shown in FIG. 2, cosmetic product segments 250 are arranged substantially horizontally within each cluster 210. For example, segment one 252 is located to the left of segment two 254, which is in turn located to the left of segment three 256. As shown in FIG. 2, segment 250 arrangement may be consistent across all clusters 210 as pictured, or it may differ from cluster to cluster.

FIG. 2 illustrates an exemplary array 200 of cosmetic product clusters 210 designed to help consumers obtain a desired end-look. Sensory assets 274 may help distinguish clusters 210 from one another, cosmetic product segments 250 from one another, or clusters 210 from segments 250. In one embodiment, visual assets such as color 276, images 278, and words 280 help convey to consumers the various desired end-looks clusters 210 represent. Further exemplary uses of sensory assets 274 include education about shade/trends, information about product form/benefits, and shade selection. One or more sensory assets 274 may be located in a variety of places amongst and around array 200. In certain embodiments, use of a dominant color 276 in cluster 210 backgrounds and cosmetic product segments 250 helps distinguish one cluster or segment from another; color 276 also helps consumers navigate through desired end-looks. In particular embodiments, sensory assets 274 may be used to distinguish cosmetic products from other cosmetic products; sensory assets may also be used on or around cosmetic products to show which clusters 210 and segments 250 they belong to; for instance, cosmetic products 214 belonging to first cluster 212 may all have purple packaging, while the products 218 belonging to second cluster 216 have blue packaging, and the products 222 belonging to third cluster 220 have green packaging. Or, color 276 may be used to frame clusters 210 and segments 250 or simply designate an edge of clusters 210, as pictured in FIG. 2. In particular embodiments, images 278 may be used to illustrate a desired end-look within each cluster 210, highlight tips and trends, exhibit products, etc. In one embodiment, images 278 comprise model photography depicting distinct desired end-looks. In some embodiments, words 280 may be helpful to distinguish clusters 210, define or describe desired end-looks and products, educate about shades/trends, inform about product form/benefits, etc. In one embodiment, words 280 comprise a set of key words that best describe each end-look. In one embodiment, various sensory assets 274 are used in combination.

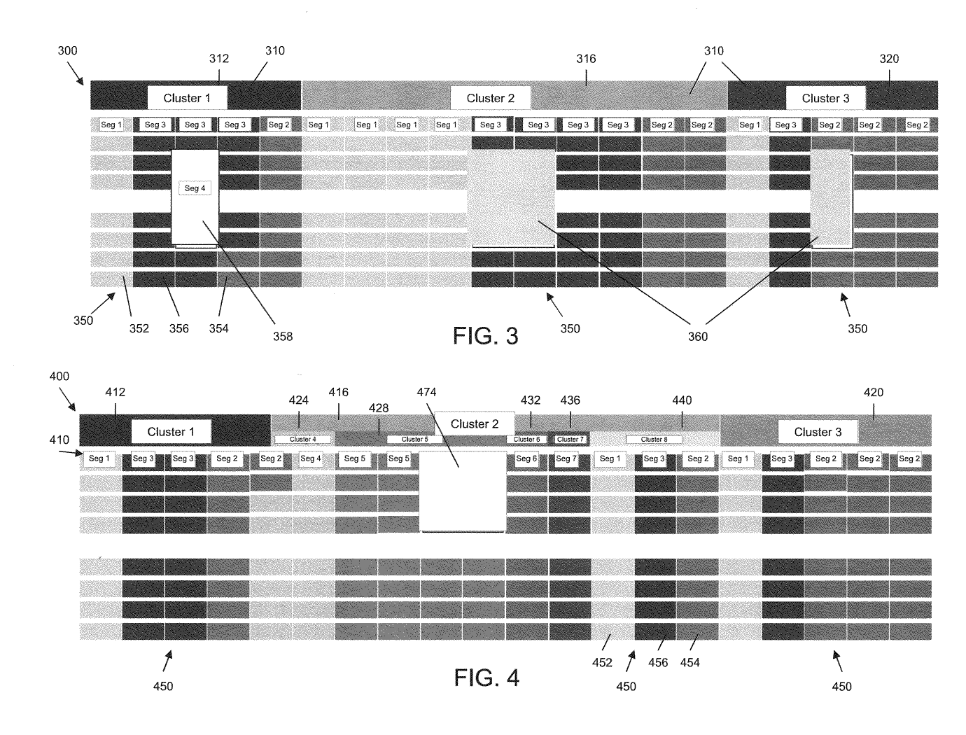

FIG. 3 illustrates an exemplary array 300 of cosmetic product clusters 310 designed to help consumers obtain a desired end-look. In some embodiments, segments 350 within each cluster 310 may vary. For example, cluster 312 comprises segment one 352, segment two 354, segment three 356, and segment four 358; while cluster 316 and cluster 320 do not comprise segment four 358. In one embodiment, cosmetic implements 360 are present in more than one cluster 310.

FIG. 4 illustrates an exemplary array 400 of cosmetic product clusters 410 designed to help consumers obtain a desired end-look. Clusters 410 may comprise differing segments 450. In a particular embodiment, first cluster 412 and third cluster 420 may comprise three segments 450, while second cluster 416 comprises five segments 450, wherein the eighth cluster 440 comprises three segments 450 which correspond to segments 450 in clusters 412, 420.

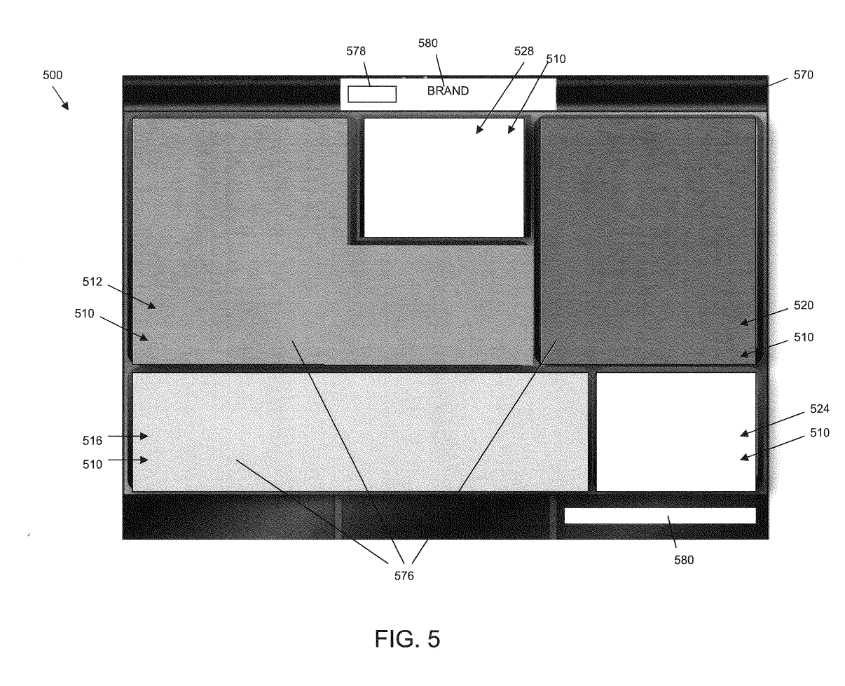

FIG. 5 illustrates an exemplary array 500 of cosmetic product clusters 510 designed to help consumers obtain a desired end-look. In some embodiments, clusters 510 may be arranged in rectangular or non-rectangular blocks. Clusters 510 may be further divided into segments 550. And, in some embodiments, sensory assets 574 may be used to distinguish clusters 510 from one another. In a one embodiment, color 576 may be used to separate clusters 510; for instance, first cluster 512 has a pink background, second cluster 516 has a blue background, third cluster 520 has a green background, fourth cluster 524 and fifth cluster 528 have no colored background. Images 578 and words 580 may also be used to describe and distinguish clusters, as well as cosmetics brands overall.

Additionally, the present invention comprises an exemplary method of merchandising cosmetic products comprising the steps of: 1. defining two or more desired end-looks; and 2. clustering the cosmetic products according to the desired end-looks such that two or more clusters of cosmetic products are formed and such that the cosmetic products in each cluster enable consumers to achieve the desired end-looks. Exemplary desired end-looks include pure chic, playfully edgy, my best me, natural, classic, dramatic, young, middle age, mature, evening, formal, work, professional, casual, anti-aging, organic/mineral, current trends, color pop, fresh faces, AM to PM perfect, and combinations thereof. In one embodiment, at least two clusters comprise at least two cosmetic product segments selected from eye products, face products, lip products, nail products, and cosmetic implements. In one embodiment, within each segment there is at least one product that is not present in a corresponding segment of any other cluster. The clusters and segments may be distinguished from one another by sensory assets, wherein the sensory assets are selected from the group consisting of color, finish, transparency, images, alphanumeric characters, printed words, audio words, nomenclature, typography, icons, patterns, shapes, objects, illumination, music, sounds, perfumes, scents, and combinations thereof. In some embodiments, clusters are displayed in a display system comprising retail fixturing, printed instruction, printed flyer, printed advertisement, electronic advertisement, interne site, and combinations thereof.

The present invention comprises a second exemplary method of merchandising cosmetic products comprising the steps of: 1. clustering the cosmetic products into eye products, lip products, face products, nail products, and cosmetic implements such that two or more clusters of cosmetic products are formed; and 2. defining two or more desired end-looks, wherein at least two clusters comprise at least two cosmetic product segments selected from various desired end-looks. In one embodiment, within each segment there is at least one product that is not present in a corresponding segment of any other cluster.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An array of cosmetic product clusters designed to help consumers obtain a desired end-look, the array comprising:
a. a first cluster comprising cosmetic products corresponding to a first desired end-look; and
b. a second cluster comprising cosmetic products corresponding to a second desired end-look;
wherein the clusters are adjacent to one another, and wherein each cluster comprises at least two cosmetic product segments selected from eye products, face products, lip products, nail products, and cosmetic implements; wherein within each segment there is at least one individual cosmetic product that is not present in a corresponding segment of any other cluster.

2. The array of cosmetic product clusters according to claim 1, wherein within each segment there is at least one individual cosmetic product that is not present anywhere else in the array.

3. The array of cosmetic product clusters according to claim 1, wherein the cosmetic product segments are arranged in a substantially vertical orientation within each cluster.

4. The array of cosmetic product clusters according to claim 1, wherein the cosmetic product segments are arranged in a substantially horizontal orientation within each cluster.

5. The array of cosmetic product clusters according to claim 1, wherein the clusters are distinguished from one another by sensory assets.

6. The array of cosmetic product clusters according to claim 5, wherein the sensory assets are selected from the group consisting of color, finish, transparency, images, alphanumeric characters, printed words, audio words, nomenclature, typography, icons, patterns, shapes, objects, illumination, music, sounds, perfumes, scents, and combinations thereof.

7. The array of cosmetic product clusters according to claim 1, wherein the segments are distinguished from one another by sensory assets.

8. The array of cosmetic product clusters according to claim 1, wherein the cosmetic products and clusters comprise sensory assets, wherein the sensory assets of the cosmetic products corresponding to the first desired end-look resemble the sensory assets of the first cluster, and wherein the sensory assets of the cosmetic products corresponding to the second desired end-look resemble the sensory assets of the second cluster.

9. The array of cosmetic product clusters according to claim 1, the array comprising a third cluster comprising cosmetic products corresponding to a third desired end-look.

10. The array of cosmetic product clusters according to claim 1, wherein the desired end-looks are selected from the group consisting of pure chic, playfully edgy, my best me, natural, classic, dramatic, young, middle-age, mature, evening, formal, work, professional, casual, anti-aging, organic/mineral, current trends, color pop, fresh faces, AM to PM perfect, and combinations thereof.

11. The array of cosmetic product clusters according to claim 1, the array comprising one or more clusters identifying a beauty issue and comprising products to address that issue.

12. The array of cosmetic product clusters according to claim 1, the array comprising one or more clusters comprising cosmetic implements.

13. The array of cosmetic product clusters according to claim 1, wherein the clusters are displayed in a display system, the display system selected from the group consisting of retail fixturing, printed instruction, printed flyer, printed advertisement, electronic advertisement, internet site, and combinations thereof.

14. A method of merchandising cosmetic products comprising the steps of:
a. defining two or more desired end-looks; and
b. clustering the cosmetic products according to the desired end-looks such that two or more clusters of cosmetic products are formed and such that the cosmetic products in each cluster enable consumers to achieve the desired end-looks;
wherein at least two clusters comprise at least two cosmetic product segments selected from eye products, face products, lip products, nail products, and cosmetic implements;
wherein within each segment there is at least one individual cosmetic product that is not present in a corresponding segment of any other cluster.

15. The method of claim 14, wherein the clusters are distinguished from one another by sensory assets, wherein the sensory assets are selected from the group consisting of color, finish, transparency, images, alphanumeric characters, printed words, audio words, nomenclature, typography, icons, patterns, shapes, objects, illumination, music, sounds, perfumes, scents, and combinations thereof.

16. The method of claim 14, wherein the segments are distinguished from one another by sensory assets.

17. The method of claim 14, wherein the desired end-looks are selected from the group consisting of: pure chic, playfully edgy, my best me, natural, classic, dramatic, young, middle age, mature, evening, formal, work, professional, casual, anti-aging, organic/mineral, current trends, color pop, fresh faces, AM to PM perfect, and combinations thereof.

18. The method of claim 14, wherein the clusters are displayed in a display system, the display system selected from the group consisting of retail fixturing, printed instruction, printed flyer, printed advertisement, electronic advertisement, interne site, and combinations thereof.

19. A cosmetic products display system comprising:
a. a space for displaying cosmetic products that consumers can use to obtain one or more desired end-looks; and
b. sensory assets that (i) divide the space into a plurality of adjacent clusters, (ii) identify a first cluster comprising for-purchase cosmetic products corresponding to a first desired end-look, and (iii) identify a second cluster comprising for-purchase cosmetic products corresponding to a second desired end-look;
wherein the clusters are adjacent to one another; wherein each cluster comprises at least two cosmetic product segments selected from eye products, face products, lip products, nail products, and cosmetic implements; and wherein within each segment there is at least one individual cosmetic product that is not present in a corresponding segment of any other cluster.

20. The display system of claim 19, wherein the sensory assets identify a third cluster comprising for-purchase cosmetic products corresponding to a third desired end-look.
